(19) United States
(12) Patent Application Publication
(10) Pub. No.: US 2022/0373861 A1
(43) Pub. Date: Nov. 24, 2022

(54) Webcam Privacy Assembly

(71) Applicant: Gill Gilliam, Freeport, IL (US)

(72) Inventor: Gill Gilliam, Freeport, IL (US)

(21) Appl. No.: 17/324,847

(22) Filed: May 19, 2021

(51) Int. Cl. G03B 11/04; G06F 1/16

(52) U.S. Cl. CPC G03B 11/043; G06F 1/1686

(57) ABSTRACT

A webcam privacy assembly includes a frame that is comprised of an elastomeric material for positioning around an electronic monitor. A camera slot is integrated into the frame to facilitate a webcam on the electronic monitor to be exposed when the frame is positioned around the electronic monitor. A flap is movably integrated into the frame and the flap is aligned with the camera slot. The flap is positionable in a closed position or an open position to cover or uncover the webcam, respectively. A pair of first mating members is each of the coupled to the flap and a pair of second mating members is each coupled to the frame. Each of the first mating members is releasably matable to a respective one of the second mating members for retaining the flap in the closed position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to privacy devices and more particularly pertains to a new privacy device for inhibiting a webcam from capturing video footage without a user's knowledge. The device includes an elastomeric frame that is positionable around an electronic display and a camera slot in the elastomeric frame for exposing a webcam on the electronic monitor. A flap is coupled to the elastomeric frame for either covering or exposing the webcam.

### (2) Description of Related Art Including Information Disclosed Under 37 CFR 1.97 and 1.98.

The prior art relates to privacy devices including a variety of smart device cases that each has a camera aperture integrated therein for exposing a camera on the smart device. The prior art discloses a brief case design that has a camera aperture extending through the brief case thereby facilitating a camera on a laptop computer to be exposed when the laptop computer is positioned in the brief case. In no instance does the prior art disclose an elastomeric frame that includes a flap for covering a webcam on an electronic display.

### BRIEF SUMMARY OF THE INVENTION

An embodiment of the disclosure meets the needs presented above by generally comprising a frame that is comprised of an elastomeric material for positioning around an electronic monitor. A camera slot is integrated into the frame to facilitate a webcam on the electronic monitor to be exposed when the frame is positioned around the electronic monitor. A flap is movably integrated into the frame and the flap is aligned with the camera slot. The flap is positionable in a closed position or an open position to cover or uncover the webcam, respectively. A pair of first mating members is each of the coupled to the flap and a pair of second mating members is each coupled to the frame. Each of the first mating members is releasably matable to a respective one of the second mating members for retaining the flap in the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a webcam privacy assembly according to an embodiment of the disclosure.

FIG. 2 is a back view of an embodiment of the disclosure.

FIG. 3 is a top view of an embodiment of the disclosure.

FIG. 4 is a front in-use view of an embodiment of the disclosure.

FIG. 5 is a left side in-use view of an embodiment of the disclosure.

FIG. 6 is a detail view taken from circle 6 of FIG. 4 of an embodiment of the disclosure.

FIG. 7 is an exploded perspective view of an alternative embodiment of the disclosure.

FIG. 8 is a front perspective view of an alternative embodiment of the disclosure.

FIG. 9 is an exploded perspective view of an alternative embodiment of the disclosure.

FIG. 10 is a detail view taken from circle 10 of FIG. 9 of an embodiment of the disclosure.

### DETAILED DESCRIPTION OF THE INVENTION

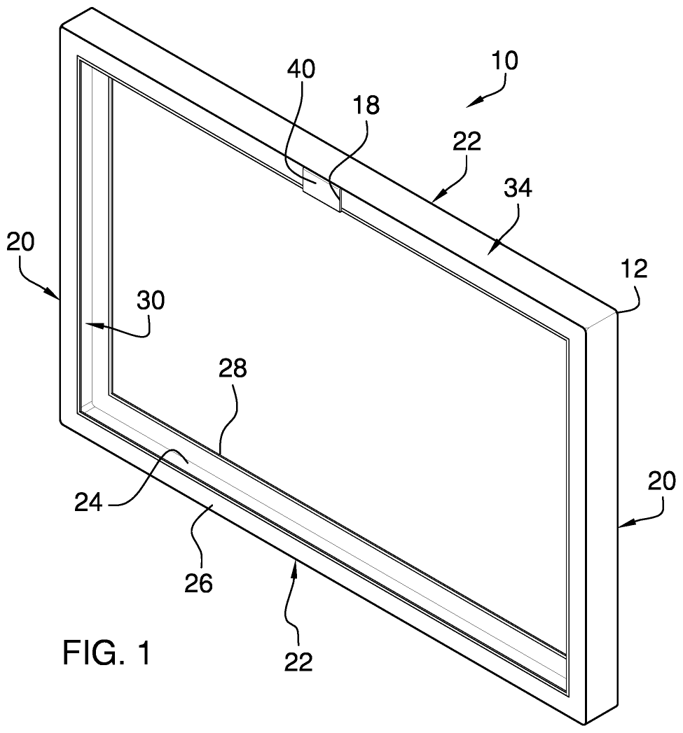

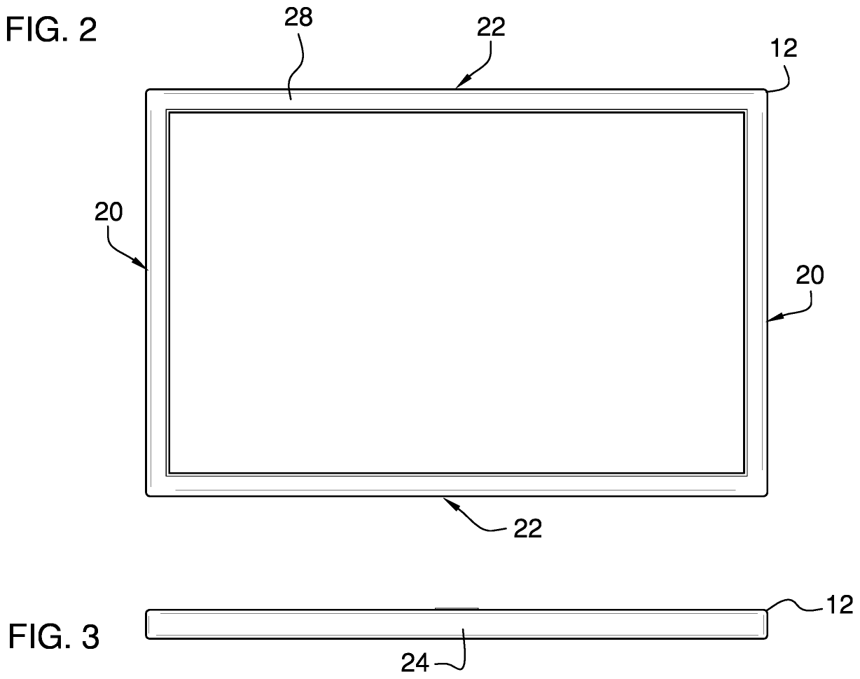

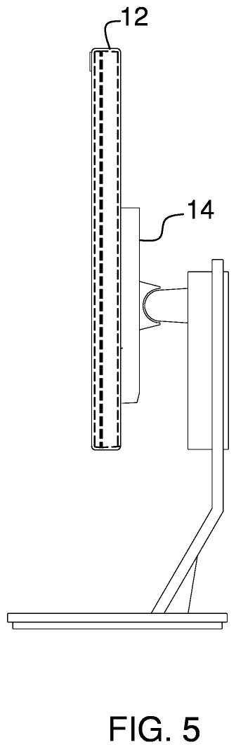

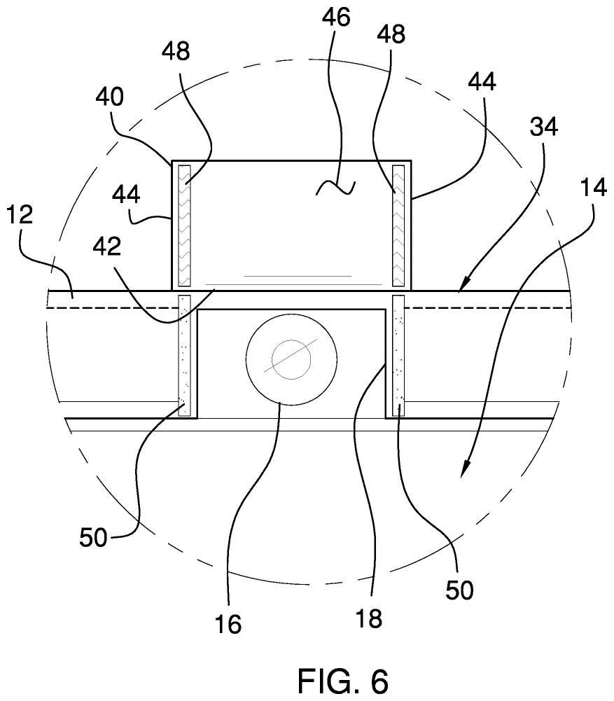

With reference now to the drawings, and in particular to FIGS. 1 through 10 thereof, a new privacy device embodying the principles and concepts of an embodiment of the disclosure and generally designated by the reference numeral 10 will be described.

As best illustrated in FIGS. 1 through 10, the webcam privacy assembly 10 generally comprises a frame 12 that is comprised of an elastomeric material thereby facilitating the frame 12 to be positioned around an electronic monitor 14. The electronic monitor 14 may be a computer monitor or other type of electronic monitor that has a digital webcam 16 integrated into the electronic monitor 14. The frame 12 has a camera slot 18 is integrated into the frame 12 to facilitate the webcam 16 on the electronic monitor 14 to be exposed when the frame 12 is positioned around the electronic monitor 14.

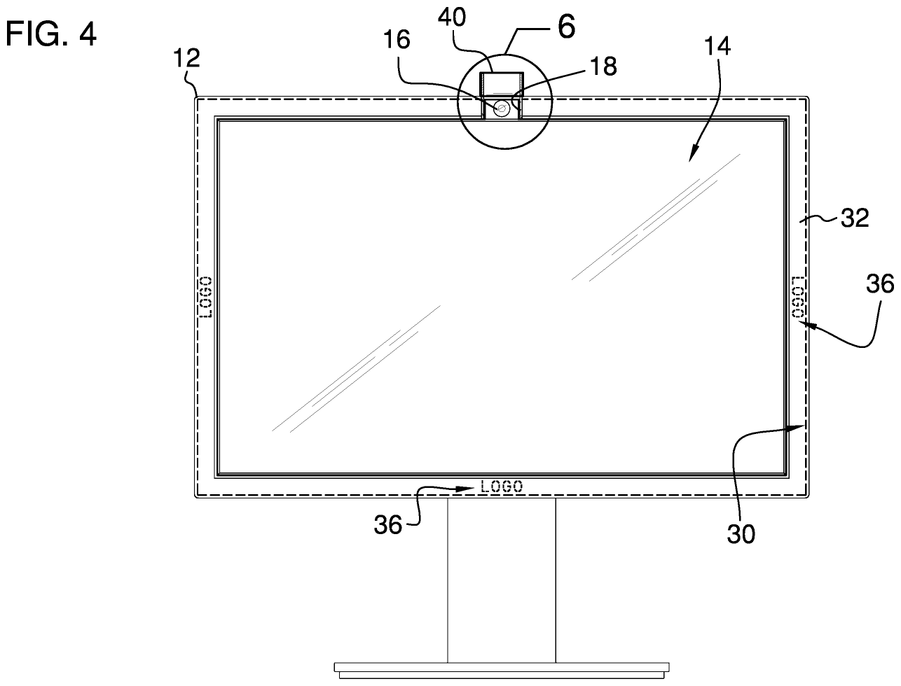

The frame 12 comprises a pair of vertical portions 20 each extending between a pair of horizontal portions 22 such that the frame 12 defines a rectangle. Each of the vertical portions 20 and each of the horizontal portions 22 comprise a central panel 24 that extends between a front panel 26 and a back panel 28. In this way each of the vertical portions 20 and each of the horizontal portions 22 define a channel 30 to insertably receive an outer edge 32 of the electronic monitor 14. The pair of vertical portions 20 includes an upper portion 34, the camera slot 18 extends through the front panel 26 of the upper portion 34 and the camera slot 18 is centrally positioned between the horizontal portions 22. As is most clearly shown in FIG. 4, indicia 36 may be printed on an outer surface 38 of the front panel 26 of the vertical portions 20 and the horizontal portions 22. The indicia 36 may comprise a logo of a sport's team, a logo of a consumer product, words communicating an idea or any other kind of imagery.

A flap 40 is movably integrated into the frame 12 and the flap 40 is aligned with the camera slot 18. The flap 40 is positionable in a closed position has the flap 40 covering the camera slot 18 thereby covering the webcam 16. In this the webcam 16 is inhibited from capturing video footage without a user's knowledge or authorization. Conversely, the flap 40 is positionable in an open position having the camera slot 18 being uncovered to expose the webcam 16. In this way the webcam 16 can function normally. The flap 40 has an upper edge 42, a pair of lateral edges 44 and a first surface 46, and the upper edge 42 is coupled to the front panel 26 of the upper portion 34 at a point that is located above the camera slot 18.

A pair of first mating members 48 is each coupled to the flap 40 and each of the first mating members 48 is positioned on the first surface 46 of the flap 40. Each of the first mating members 48 is aligned with a respective one of the lateral edges 44 of the flap 40. A pair of second mating members 50 is each coupled to the frame 12 and each of the first mating members 48 is releasably matable to a respective one of the second mating members 50 for retaining the flap 40 in the closed position. Each of the second mating members 50 is positioned on the front panel 26 of the upper portion 34 and each of the second mating members 50 is positioned on opposite sides of the camera slot 18 with respect to each other. Additionally, of the first mating members 48 and the second mating members 50 may comprise a hook and loop fastener or other type of releasable fastener.

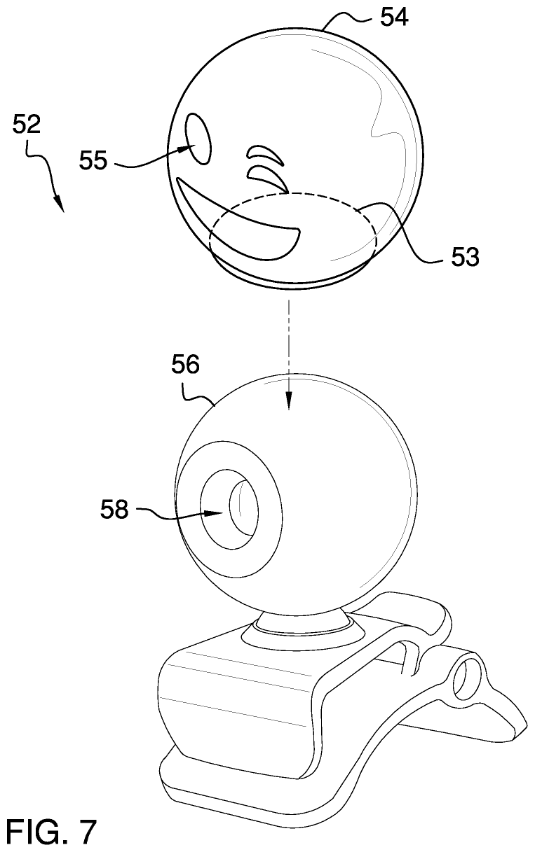

In an alternative embodiment 52 as is most clearly shown in FIG. 7, a sphere 54 is provided that has an entrance 53 extending into an interior of the sphere 54. In this way the sphere 54 can be positioned around a spherical webcam 56. The sphere 54 has a lens opening 55 extending into the interior of the sphere 54. The lens opening 55 is displaced from the entrance 53 such that the lens opening 55 can be aligned with a lens 58 on the spherical webcam 56 when the sphere 54 is positioned around the spherical webcam 56. The sphere 54 is comprised of an elastomeric material to accommodate a variety of sizes of spherical webcams 56.

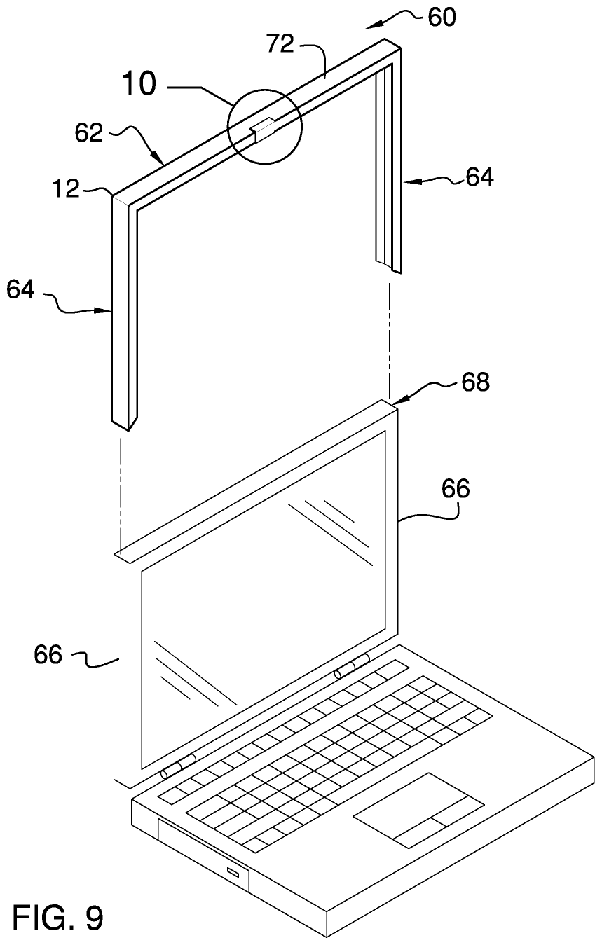

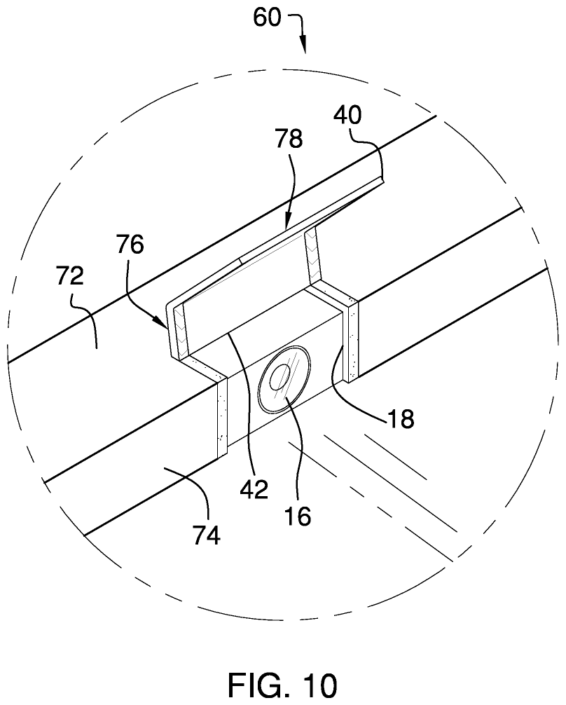

In an alternative embodiment 60 as is most clearly shown in FIGS. 9 and 10, the frame 12 comprises a middle portion 62 extending between a pair of end portions 64 such that the frame 12 has a U-shape. Each of the end portions 64 is slidable onto a respective lateral edge 66 of a display 68 of a laptop computer having the middle portion 62 resting on a top edge 70 of the display 68. The middle portion 62 has a top panel 72 and a forward panel 74. The camera slot 18 extends through the forward panel 74 and partially through the top panel 72 to expose a webcam 16 that is positioned adjacent to the top edge 70 of the display 68.

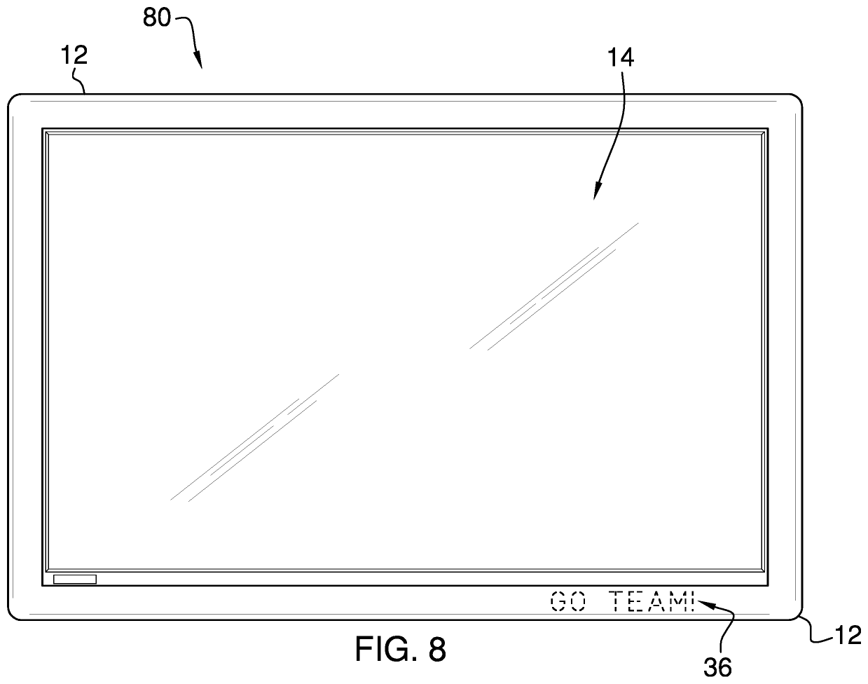

Continuing in the alternative embodiment 60 in FIGS. 9 and 10, the flap 40 includes a first section 76 that forms an angle with a second section 78, and the upper edge 42 of the flap 40 is associated with the first section 76. The upper edge 42 is coupled to the top panel 72 of the middle portion 62. The first section 76 covers the camera slot 18 in the top panel 72 when the flap 40 is closed. Additionally, the second section 78 covers the camera slot 18 in the forward panel 74 when the flap 40 is closed. In an alternative embodiment 80 as is most clearly shown in FIG. 8, the camera slot 18 may be absent from the frame 12.

In use, the frame 12 is positioned around the electronic monitor 14 such that the camera slot 18 is aligned with the webcam 16. In this way the flap 40 can be closed to cover the webcam 16. Thus, the user can rest assured that the webcam 16 cannot capture video footage without the user's knowledge. The flap 40 can be opened to expose the webcam 16. In this way the webcam 16 can function normally for capturing video footage. Additionally, the indicia 36 on the frame 12 can enhance the visual appeal of the electronic monitor 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A webcam privacy assembly for covering a webcam when the webcam is not being used, said assembly comprising:
a frame being comprised of an elastomeric material wherein said frame is configured to be positioned around an electronic monitor, said frame having a camera slot being integrated into said frame wherein said camera slot is configured to facilitate a webcam on the electronic monitor to be exposed when said frame is positioned around the electronic monitor;
a flap being movably integrated into said frame, said flap being aligned with said camera slot, said flap being positionable in a closed position having said flap covering said camera slot wherein said flap is configured to cover the webcam, said flap being positionable in an open position having said camera slot being uncovered wherein said flap is configured to expose the webcam;
a pair of first mating members, each of said first mating members being coupled to said flap;
a pair of second mating members, each of said second mating members being coupled to said frame, each of said first mating members being releasably matable to a respective one of said second mating members for retaining said flap in said closed position.

2. The assembly according to claim 1, wherein said frame comprises a pair of vertical portions each extending between a pair of horizontal portions such that said frame defines a rectangle, each of said vertical portions and each of said horizontal portions comprising a central panel extending between a front panel and a back panel such that each of said vertical portions and each of said horizontal portions defines a channel wherein said channel is configured to insertably receive an outer edge of the electronic monitor, said pair of vertical portions including an upper portion, said camera slot extending through said front panel of said upper portion, said camera slot being centrally positioned between said horizontal portions.

3. The assembly according to claim 2, wherein said flap has an upper edge, a pair of lateral edges and a first surface, said upper edge being coupled to said front panel of said upper portion at a point being located above said camera slot.

4. The assembly according to claim 1, wherein:
said flap has an upper edge, a pair of lateral edges and a first surface;
said frame includes an upper portion, said upper portion having a front panel, said camera slot extending through said front panel;
each of said first mating members is positioned on said first surface of said flap, each of said first mating members being aligned with a respective one of said lateral edges of said flap; and
each of said second mating members is positioned on said front panel of said upper portion, each of said second mating members being positioned on opposite sides of said camera slot with respect to each other.

5. A webcam privacy assembly for covering a webcam when the webcam is not being used, said assembly comprising:
a frame being comprised of an elastomeric material wherein said frame is configured to be positioned around an electronic monitor, said frame having a camera slot being integrated into said frame wherein said camera slot is configured to facilitate a webcam on the electronic monitor to be exposed when said frame is positioned around the electronic monitor, said frame comprising a pair of vertical portions each extending between a pair of horizontal portions such that said frame defines a rectangle, each of said vertical portions and each of said horizontal portions comprising a central panel extending between a front panel and a back panel such that each of said vertical portions and each of said horizontal portions defines a channel wherein said channel is configured to insertably receive an outer edge of the electronic monitor, said pair of vertical portions including an upper portion, said camera slot extending through said front panel of said upper portion, said camera slot being centrally positioned between said horizontal portions;
a flap being movably integrated into said frame, said flap being aligned with said camera slot, said flap being positionable in a closed position having said flap covering said camera slot wherein said flap is configured to cover the webcam, said flap being positionable in an open position having said camera slot being uncovered wherein said flap is configured to expose the webcam, said flap having an upper edge, a pair of lateral edges and a first surface, said upper edge being coupled to said front panel of said upper portion at a point being located above said camera slot;
a pair of first mating members, each of said first mating members being coupled to said flap, each of said first mating members being positioned on said first surface of said flap, each of said first mating members being aligned with a respective one of said lateral edges of said flap; and
a pair of second mating members, each of said second mating members being coupled to said frame, each of said first mating members being releasably matable to a respective one of said second mating members for retaining said flap in said closed position, each of said second mating members being positioned on said front panel of said upper portion, each of said second mating members being positioned on opposite sides of said camera slot with respect to each other.

6. The assembly according to claim 5, further comprising a sphere having an entrance extending into an interior of said sphere wherein said sphere is configured to be positioned around a spherical webcam, said sphere having a lens opening extending into said interior of said sphere, said lens opening being displaced from said entrance wherein said lens opening is configured to be aligned with a lens on the spherical webcam when said sphere is positioned around the spherical webcam, said sphere being comprised of an elastomeric material wherein said sphere is configured to accommodate a variety of sizes of spherical webcams.

7. The assembly according to claim 5, wherein said frame comprises a middle portion extending between a pair of end portions such that said frame has a U-shape, each of said end portions being slidable onto a respective lateral edge of a display of a laptop computer having said middle portion resting on a top edge of the display, said middle portion having a top panel and a forward panel, said camera slot extending through said forward panel and partially through said top panel wherein said camera slot is configured to expose a webcam that is positioned adjacent to the top edge of the display.

8. The assembly according to claim 7, wherein said flap includes a first section forming an angle with a second section, said upper edge of said flap being associated with said first section, said upper edge being coupled to said top panel of said middle portion, said first section covering said camera slot in said top panel when said flap is closed, said second section covering said camera slot in said front panel when said flap is closed.

9. A webcam privacy system for covering a webcam when the webcam is not being used, said system comprising:
an electronic monitor having a webcam being integrated into said electronic monitor;
a frame being comprised of an elastomeric material thereby facilitating said frame to be positioned around said electronic monitor, said frame having a camera slot being integrated into said frame to facilitate said webcam on said electronic monitor to be exposed when said frame is positioned around said electronic monitor, said frame comprising a pair of vertical portions each extending between a pair of horizontal portions such that said frame defines a rectangle, each of said vertical portions and each of said horizontal portions comprising a central panel extending between a front panel and a back panel such that each of said vertical portions and each of said horizontal portions defines a channel to insertably receive an outer edge of said electronic monitor, said pair of vertical portions including an upper portion, said camera slot extending through said front panel of said upper portion, said camera slot being centrally positioned between said horizontal portions;
a flap being movably integrated into said frame, said flap being aligned with said camera slot, said flap being positionable in a closed position having said flap covering said camera slot thereby covering said webcam, said flap being positionable in an open position having said camera slot being uncovered thereby exposing said webcam, said flap having an upper edge, a pair of lateral edges and a first surface, said upper edge being coupled to said front panel of said upper portion at a point being located above said camera slot;
a pair of first mating members, each of said first mating members being coupled to said flap, each of said first mating members being positioned on said first surface of said flap, each of said first mating members being aligned with a respective one of said lateral edges of said flap; and
a pair of second mating members, each of said second mating members being coupled to said frame, each of said first mating members being releasably matable to a respective one of said second mating members for retaining said flap in said closed position, each of said second mating members being positioned on said front panel of said upper portion, each of said second mating members being positioned on opposite sides of said camera slot with respect to each other.
